(19) United States
(12) Patent Application Publication
(10) Pub. No.: US 2002/0035516 A1
(43) Pub. Date: Mar. 21, 2002

(54) Server computer system for selling digital contents by using network, player terminal for replaying digital contents by using network, system for selling digital contents by using network, method for selling digital contents by using network, and machine-readable storage medium

(75) Inventor: Keiko Arima, Tokyo (JP)

Correspondence Address: SUGHRUE, MION, ZINN,, MACPEAK & SEAS, 2100 Pennsylvania Avenue, N.W., Washington, DC, 20037, US

(73) Assignee: NEC CORPORATION

(21) Appl. No.: 09/951,705

(22) Filed: Sep. 14, 2001

(30) Foreign Application Priority Data
Sep. 21, 2000 (JP) 286621/2000

(51) Int. Cl. G06F 17/60; G05B 11/01; G06F 7/00; G06F 17/00; G06F 15/16

(52) U.S. Cl. 705/26; 700/231; 700/17; 707/102; 709/200

(57) ABSTRACT

A user terminal 10 sends a rack creation request to a server 30; a sales center server 40 delivers contents purchased by the user terminal 10 to the server 30; the server 30 creates a rack in a database as a depository for contents for each customer in response to a rack creation request from the user terminal 10, then stores the contents delivered from the sales center server 30 in the rack, creates a list from the rack of the customer in response to a request for the list from the player terminal 20 sends it to the player terminal 20, and then sends to the player terminal 20 contents selected by the player terminal 20 in response to a download request for the selected contents.

### BACKGROUND OF THE INVENTION

1. Field of the Invention

The present invention relates to a digital contents sales system and a digital contents sales method for selling digital contents via a network, and particularly to a digital contents sales system and a digital contents sales method using a digital contents rack for storing digital contents purchased by a customer.

2. Description of the Related Prior Art

In a conventional digital contents sales system for online shopping of digital contents using a network such as the Internet and in a conventional method for storing digital contents purchased by customers, a sales center server accepts an order for digital contents from a customer via the network, and then arranges payment from the customer and downloads the digital contents to a user terminal used by the customer. The purchased digital contents are stored in the user terminal used at the time of order.

Referring to FIG. 1, a conventional digital content product sales system comprises a network 200 (the Internet) interconnecting a user terminal 50 and a sales center server 70 situated in a sales center. A customer accesses a digital contents sales website that the sales center operates on the network 200 via the user terminal 50, determines a product to purchase, and orders it through a screen of the user terminal 50. The customer specifies a payment method on the screen of the user terminal 50. The sales center server 70, which accepted the order, downloads the digital contents to the user terminal 50. The customer stores the digital contents on a disk in the user terminal 50, then replays and executes the digital contents on the user terminal 50 or on another portable player equipment 60 after copying the digital contents to the equipment from the user terminal 50.

Japanese Patent Laid-Open No. 2000-194635 entitled “A Method of and System for Distributing Digital Contents” discloses a system in which an instruction is given to distribute digital contents according to a distribution schedule, then the digital contents are distributed according to the distribution schedule indicated, and particular digital contents selected from the distributed digital contents are sold.

Japanese Patent Laid-Open No. 11-213010 entitled “Distribution System for Digital Contents” discloses a system in which digital contents are distributed as distribution data constituted by digital contents, retrieving information on the digital contents, and conditions for use of the digital contents; the digital contents are used under the conditions.

This conventional digital contents sales system has the following problems. A customer has to pay for every download to the user terminal from the sales center server. The customer needs a user terminal with a primary storage device and to manage digital contents downloaded to the user terminal by himself/herself. If the user has erased purchased contents by mistake, or if the user terminal goes wrong, or if the user changes the user terminal to another one, the user cannot replay and execute the purchased digital contents and has to purchase the same contents again.

Further, if a user is to use purchased digital contents with a portable player, the user has to activate the user terminal to copy the digital contents stored in a certain location in the user terminal to the player in advance. That is, there is a problem of temporal and spatial limitations.

In the Japanese Patent Laid-Open No. 2000-194635 entitled “A Method of and System for Distributing Digital Contents”, a license fee corresponding to the number of purchased digital contents can be distributed to each contents holder. However, there remains the unsolved problem that, if the user has erased purchased contents by mistake, or if the user terminal goes wrong, or if the user changes the user terminal to another one, the user cannot replay and execute the purchased digital contents and has to purchase the same contents again.

In the Japanese Patent Laid-Open No. 11-213010 entitled “Digital Contents Distribution System”, conditions for use of contents can be set. However, there remains the unsolved problem that, if the user has erased purchased contents by mistake, or if the user terminal goes wrong, or if the user changes the user terminal to another one, the user cannot replay and execute the purchased digital contents and has to purchase the same contents again.

### SUMMARY OF THE INVENTION

In view of the above-mentioned problems, an object of the present invention is to obtain digital contents with player terminals via a network and replay them without need of purchasing the purchased digital contents again, rather than to purchase digital contents with a user terminal and store them in a storage device in the user terminal. Another object of the invention is to download and use digital contents on demand without temporal and spatial limitations. Still another object of the invention is to collect only the use charge for digital contents and eliminate the need for a customer to pay for every download of digital contents to the customer's terminal.

To achieve these objects, a server computer system for selling digital contents using a network according to the present invention is connected via the network to user terminals, player terminals for replaying digital contents, and a sales center server storing the digital contents therein. The server computer system comprises: creating means for creating a rack in a database as a depository for digital contents for each customer in response to a creation request from the user terminal; storing means for storing digital contents received from the sales center server in the rack; list sending means for receiving a request for a list of the digital contents from the player terminal via the network and creating the list from the customer's rack to send it to the player terminal; and contents sending means for sending digital contents selected via the network by the customer using the player terminal to the player terminal in response to a download request for the selected digital contents.

A player terminal for replaying digital contents using a network according to the present invention is connected, via the network, to user terminals, a server computer, and a sales center server storing the digital contents therein. The player terminal comprises: displaying means for displaying a list of digital contents stored in the server computer on a screen; means for requesting download of digital contents selected by a customer from the list displayed by the displaying means; and storing and replaying means for storing contents information including the downloaded digital contents and replaying the digital contents.

In a system for selling digital contents using a network according to the present invention, user terminals, player terminals for replaying digital contents, a sales center server storing the digital contents therein, and a server computer system are interconnected via the network. The system for selling digital contents using the network is constituted by: the server computer system comprising creating means for creating a rack in a database as a depository for digital contents for each customer in response to a creation request from the user terminal, storing means for storing digital contents received from the sales center server in the rack, list sending means for receiving a request for a list of the digital contents from the player terminal via the network and creating the list from the customer's rack to send it to the player terminal, and contents sending means for sending digital contents selected by the customer with the player terminal via the network to the player terminal in response to a download request for the selected digital contents; the player terminal comprising displaying means for displaying a list of the digital contents stored in the server computer on a screen, means for requesting download of the digital contents selected by a customer from the list displayed by the displaying means, and storing and replaying means for storing contents information including the downloaded digital contents and replaying the digital contents; the sales center server comprising delivering means for accepting the customer's purchase request from the user terminal and delivering the digital contents purchased by the customer to the server computer via the network; and the user terminal comprising requesting means for requesting, via the network, creation of the rack for each customer by the server.

In a method for selling digital contents using a network according to the present invention, a server computer system for selling digital contents, a sales center server storing digital contents therein, user terminals for purchasing digital contents from the sales center server, and player terminals for replaying the digital contents are connected to the network, via which the digital contents are sold. The method comprises the steps of: connecting the server computer system and the player terminal to the network; presenting, on the network, a service that the server computer system provides a digital contents rack for each customer; storing, in the digital contents rack in the server computer system, digital contents purchased by a customer from the sales center server via the network with the user terminal; and downloading the digital contents to the player terminal from the rack in response to a download request from the player terminal.

A machine-readable storage medium according to the present invention has a digital contents sales program recorded thereon for selling digital contents via a network by connecting, to the network, a server computer system for selling digital contents, a sales center server storing digital contents therein, user terminals for purchasing digital contents from the sales center server, and player terminals for replaying the digital contents. The machine-readable storage medium comprises the processes of: connecting the server computer system and the player terminal to the network; presenting, on the network, a service that the server computer system provides a digital contents rack for each customer; storing, in the digital contents rack in the server computer system, digital contents purchased by a customer from the sales center server via the network with the user terminal; and downloading the digital contents to the player terminal in response to a download request from the player terminal.

### BRIEF DESCRIPTION OF THE DRAWINGS

The above and other objects, features and advantages of the present invention will become apparent from the following detailed description when taken with the accompanying drawings in which:

FIG. 1 is a block diagram showing a conventional digital contents sales system;

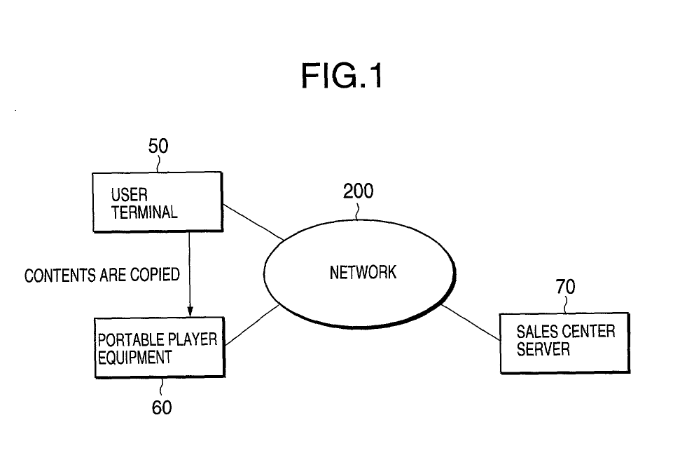

FIG. 2 is a block diagram showing an embodiment of the present invention;

FIG. 3 is a flow chart showing system operations for creating a digital contents rack according to the present invention;

FIG. 4 is a schematic view showing an exemplary screen displayed on a user terminal according to the present invention;

FIG. 5 is a flow chart showing system operations for selling digital contents according to the present invention; and

FIG. 6 is a flow chart showing system operations for using contents in the digital contents rack according to the present invention.

### DETAILED DESCRIPTION OF THE PREFERRED EMBODIMENTS

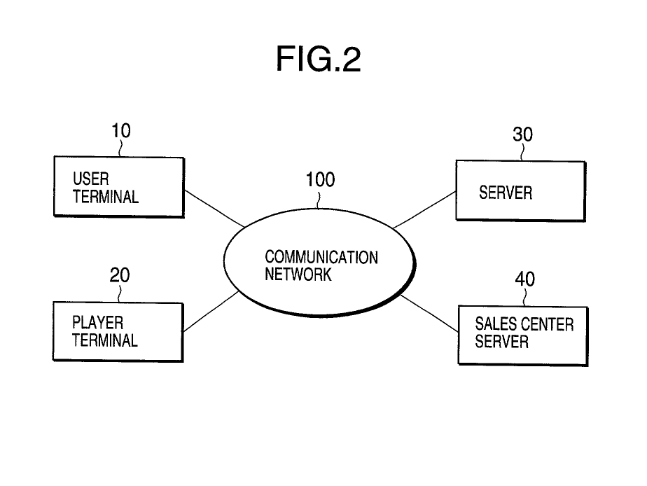

Now, an embodiment of the present invention will be described with reference to the drawings. Referring to FIG. 2, the embodiment of the present invention consists of user terminals 10, player terminals 20, a server 30 including digital contents racks, a sales center server 40, and a communication network 100, such as the Internet, which inter connects these terminals and servers. The user terminal 10 and the player terminal 20 may also be embodied together in one terminal.

The user terminal 10 is an information processing apparatus such as a personal computer or mobile phone. The user terminal 10 has a screen and a communication function for wired or wireless access to the communication network 100. The screen is a display for displaying images and texts. The user terminal 10 has a function for accessing a website of the server 30 connected to the communication network 100 to request creation of a digital contents rack. The user terminal 10 requests the server 30 to create the digital contents rack by inputting, through the screen of the user terminal 10, a user ID, a password, and player terminal IDs to be used for downloading digital contents. The user terminal 10 also has a function for requesting registration of the user ID, the password, and the player terminal IDs, and requesting change of the player terminal IDs registered with the digital contents rack.

The server 30 is an information processing apparatus such as a workstation or personal computer. The server 30 includes a storage for storing information on the website that the user terminal 10 accesses and for storing a database in which the digital contents racks for customers are created. The storage is, for example, a storage device such as a magnetic or optical disk. The storage device of the server 30 maintains a storage area for the website and a storage area for the contents rack database. The storage area for the contents rack database is located and accessed by URLs.

The server 30 has a function for creating a digital contents rack in the storage area for the contents rack database in response to a request from a customer's user terminal 10, and a function for allowing a customer to change the player terminal IDs registered with the rack. A digital contents rack has a function for storing digital contents purchased by a customer and delivered from the sales center server 40 when it is designated as a delivery destination.

The server 30 also has a function for receiving a request for a list of contents in a customer s rack from the customer's player terminal 20 and downloading contents selected by the customer from the list to the player terminal 20, together with the expiration date and the maximum number of replays for the player. The entire digital contents racks consist of a contents storage area and a user information area. The contents storage area stores requested digital contents therein as a depository, together with contents IDs for identifying the digital contents.

A given area in the user information area is allocated to each user ID, and each area includes a password area for saving the password, a player terminal ID area with which a plurality of player terminal IDs can be registered, a link information area for storing link information pointing to locations where digital content products are stored, and a contract information area for storing contract information. The link information area further includes information on the expiration date and the maximum number of replays for each purchased digital contents.

The user information area of the digital contents racks stores therein user information on each digital contents rack. When a digital contents rack for a certain user ID is to be accessed, the user ID and the password registered with the user information area for the digital contents rack have to be authorized.

The sales center server 40 is an information processing apparatus such as a personal computer or a workstation. The sales center server 40 has a storage for storing information on the website accessed by the user terminal 10, and information on digital contents for sale such as sound, images, text information, and software. The storage is, for example, a storage device such as a magnetic or optical disk. The sales center server 40 has a function for accepting a purchase request for digital contents from the user terminal 10 and accessing the server 30 having the customer's digital contents rack as a delivery destination.

These information processing apparatus such as personal computers or workstations operate under program control. The program may be stored in machine-readable storage medium.

The player terminal 20 is an apparatus having a screen, memory, a wired or wireless access function to the network 100, and a function for replay and execution of digital contents. The player terminal 20 has a preset unique player terminal ID. The player terminal 20 has functions for receiving input of a user ID and a password from a customer, sending them to the server 30, requesting a list of contents in the customer's rack, and requesting download of contents. It also has functions for storing downloaded digital contents in the memory, displaying the contents list in the memory on the screen, and replaying and executing the contents in the memory. It also has a function for automatically erasing contents in the memory when the contents in the memory has expired or been replayed maximum times.

Now, operations in the embodiment of the present invention will be described with reference to FIG. 2 to 6. In the following description, the Internet is adopted as the communication network 100. Thus, the server 30, the sales center server 40, the player terminal 20, and the user terminal 10 exchange data over the Internet.

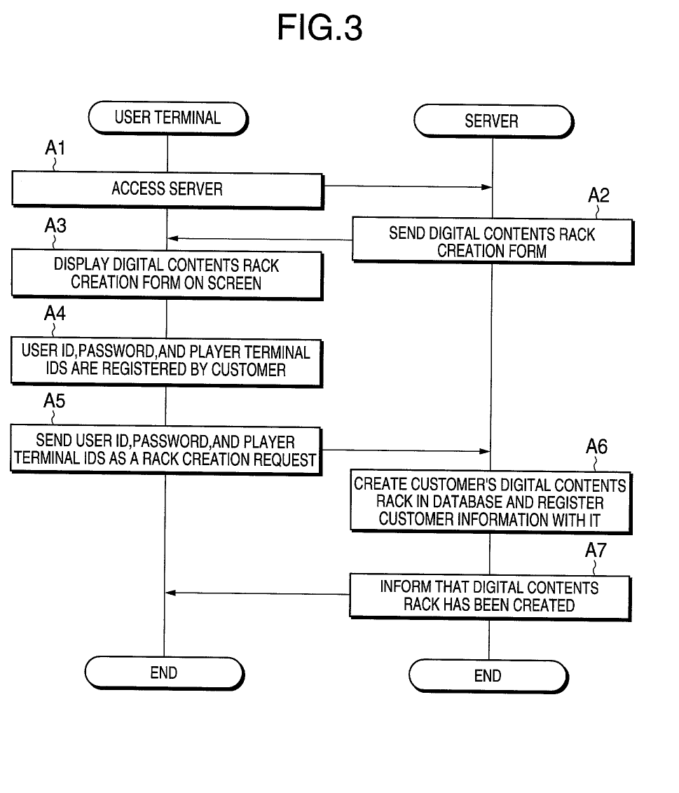

The operational flow for creating a digital contents rack will be described with reference to FIG. 3. Through the user terminal 10, a customer accesses the website that the administrator of the server 30 operates on the communication network 100 (step Al in FIG. 3). In response to this, the server 30 reads out a digital contents rack creation form from the database to send it to the user terminal 10 (step A2).

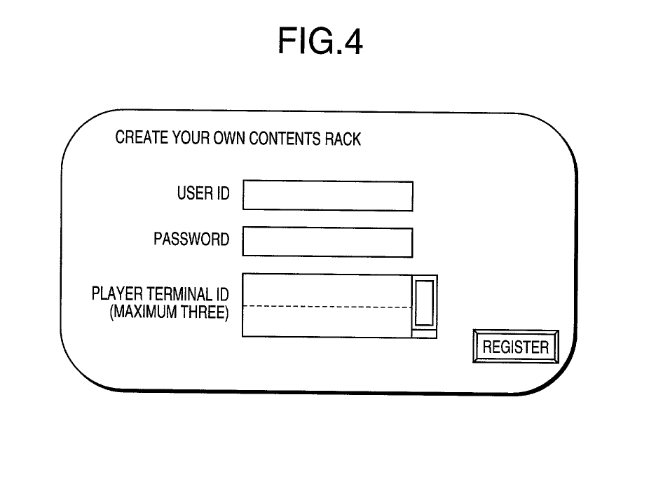

The screen of the user terminal 10 displays the digital contents rack creation form. The input screen for creating a digital contents rack includes a “new rack” button and a “change” button, wherein selecting the “new rack” causes an input form shown in FIG. 4 to be displayed (step A3). The customer inputs a user ID, a password, and player terminal IDs to be used for download from the digital contents rack on the input form displayed on the screen of the user terminal 10 (step A4) . Then, selecting the “register” button causes the input information to be sent to the server 30 as a digital contents rack creation request (step A5).

When the server 30 receives the digital contents rack creation request, it creates a digital contents rack dedicated to the customer in the database (step A6) and informs the user terminal 10 that the rack has been created (step A7). The server 30 creates the digital contents rack by defining an area for the received user ID in the user information area of the digital contents racks and registering the received user ID, the password, and the player terminal IDs with the defined area on reception of the input form.

If “change” is selected according to the input screen for creating a digital contents rack, an input screen for change is displayed. Input information on items in respective blanks is sent to the server 30. The input screen for change displays blanks for the user ID, the password, the player terminal ID to be changed, and a new player terminal ID.

In accordance with the received information, the server 30 replaces the current player terminal ID in the corresponding player terminal ID area in the user information area for the digital contents rack with the new player terminal ID. If there is no corresponding player terminal ID to be changed, the server 30 sends the user terminal 30 an error message indicating that the player terminal ID does not exist.

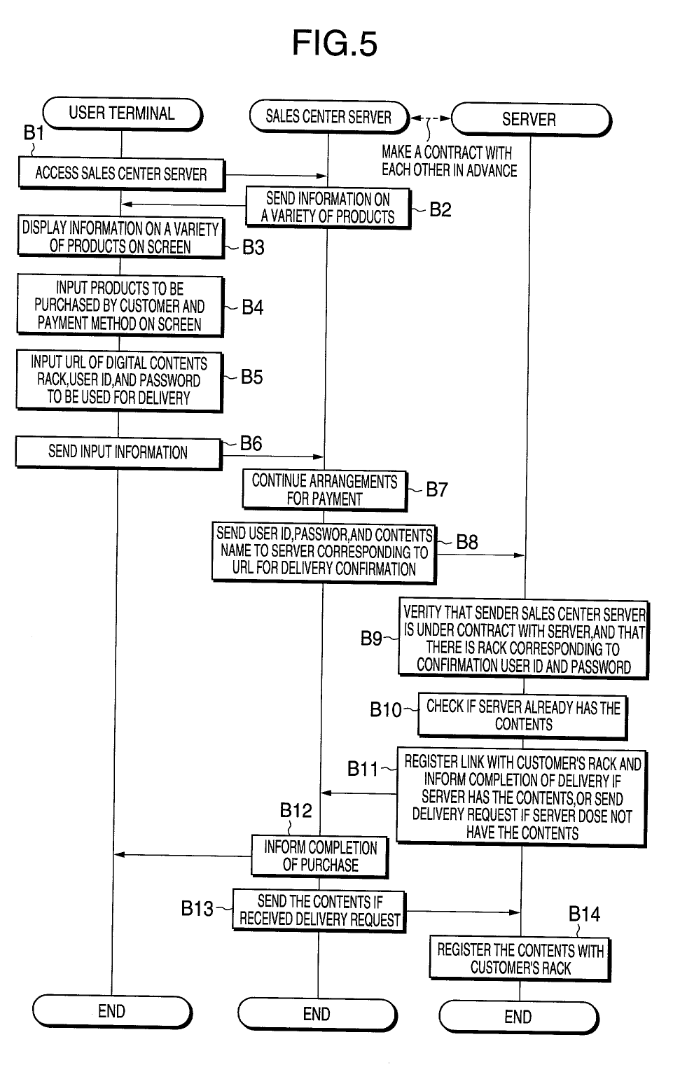

Now, the operational flow for purchasing digital contents will be described with reference to FIG. 5. Through the user terminal 10, a customer accesses the website that the digital content sales center operates on the communication network 100 (step B1). In response to this, the sales center server 40 sends a information on a variety of products to the user terminal 10 (step B2).

The user terminal 10 displays a information on a variety of products on the screen (step B3). The customer determines the contents ID of a product that the customer wants to purchase, and inputs the intention to purchase the product and the payment method (payment conditions such as the purchaser's name and credit card number) (step B4). The customer further inputs the URL (Uniform Resource Locator) of the digital contents rack as the delivery destination, and the user ID and password specified when the digital contents rack was created (step B5). The user terminal 10 sends this order information to the sales center server 40 (step B6).

On reception of the order information, the sales center server 40 arranges payment and contents delivery. For example, payment is arranged by the server 30, which sends payment information to a server of a credit card company (not shown) over the communication network 100 (step B7) . The payment information includes, for example, the purchaser name, the credit card number, and the charge.

As to the arrangements for contents delivery, the sales center server 40 sends a contents delivery confirmation request including the user ID, the password, and the digital contents name to the server 30 that serves the URL designated to receive the contents, i.e., the digital contents rack (step B8). When the server 30 receives the contents delivery confirmation request, it checks that the sender is the sales center server 40 that is under contract with-the server 30, and checks the received user ID and password of the customer against the user ID and password registered with the user information area for the designated digital contents rack (step B9). If the checking result shows that the user ID and password in the digital contents rack (specifically the user information area) match the received ones, the server 30 informs the sales server 40 that delivery is possible (step B11).

If the sales center server 40 is informed that delivery is possible, it informs the user terminal 10 that the purchase order has been accepted (step B12). It sends the digital contents information to the server 30 (step B13).

The server 30 receives the digital contents information. Then, from the received digital contents information, it retrieves the contents ID and the digital contents to store them in the contents storage area of the digital contents racks, and retrieves the contents ID, the expiration date, and the maximum number of replays to register them with the user information area of the digital contents racks (step B14). In this operational flow, the server 30 checks if the digital contents has been already stored in the server 30 when it receives the delivery confirmation request from the sales center server 40 (step B10). This is done by searching in the digital contents area of the digital contents rack with the contents ID. If the digital contents has been already stored in the area, the server 30 registers the contents ID of the digital contents with the user information area for the digital contents rack and informs the sales center server 40 that the contents has been delivered (step B11) When the sales center server 40 is informed that the contents have been delivered, the sales center server 40 informs the user terminal 10 that the purchase order has been accepted (step B12).

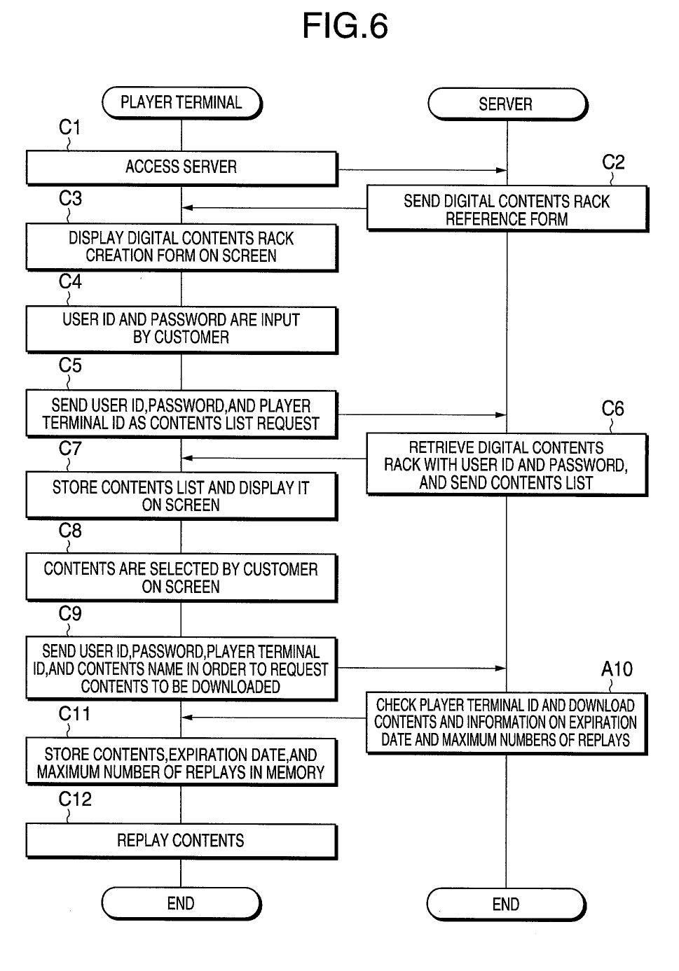

Now, an operational flow for using digital contents in a digital contents rack will be described with reference to FIG. 6. A customer accesses the website of the server 30 connected to the communication network 100 by using the player terminal 20 having a wired or wireless communication function, for example, a car stereo, a portable stereo, or a portable electronic book (step Cl). The server 30 sends the player terminal 20 an input form for referring to the digital contents rack registered with the storage (step C2).

The player terminal 20 displays the input form on the screen (step C3). The customer inputs the user ID and the password for the digital contents rack with the player terminal 20 (step C4) The player terminal 20 sends the user ID and password that have been input on the screen as well as the player terminal ID that is preset in the player terminal to the server 30 as a request for a digital contents list (step CS). The server 30 checks the received user ID, password, and player terminal ID, and then creates a digital contents list from the corresponding digital contents rack. The server 30 adds an input screen and a download request button to the created digital contents list, which is then sent to the player terminal 20 (step C6).

The digital contents list is created by the server 30, which reads out information such as contents IDs and their expiration dates and maximum numbers of replays from the link information area in the user information area of the digital contents rack for the user ID. The digital contents list is classified according to player terminal IDs. The player terminal 20 stores the received digital contents list in the memory and displays it on the screen (step C7).

The customer inputs the user ID and password, selects a digital contents that the customer wants to currently use on the player terminal 20 from the digital contents list displayed on the screen of the player terminal (step C8), and presses the download request button on the screen. The player terminal 20 sends the server terminal 30 the user ID, the password, the player terminal ID, and the contents ID (the digital contents name) as a download request (step C9)

The server 30 reads out the digital contents corresponding to the contents ID from the contents storage area of the digital contents racks. It further reads the expiration date information and the maximum number of replays information for the contents ID from the user information area of the digital contents rack and downloads the read information to the player terminal 20 as contents information (step C10) . The contents information includes the contents ID, the digital contents, the expiration date, and the maximum number of replays. When the player terminal 20 receives the contents information, it stores the contents information in the memory (step C11) and terminates the access to the server 30.

By operating the player terminal 20, the customer replays and executes the contents information while the player 20 is receiving it, or after the player 20 has received and stored it in the memory (step C12).

Next, an implementation flow where downloaded contents in the player terminal 20 becomes unavailable will be described. The player terminal 20 has a clock function, and it reads the expiration date and the maximum number of replays stored in the memory on every replay of digital contents to check the date and time and the times of replay respectively. The player terminal 20 erases contents information that has expired or been replayed maximum times from the memory. It also displays a list of automatically erased contents on the screen in response to operation by the customer.

Next, operations for collecting the use charge for digital contents rack from a customer by the server 30 will be described. In the above-described step A3, when the user terminal 10 displays an input screen on the screen, it also displays a screen for the use charge in addition to the input form. The screen for the use charge displays information such as instructions for use and the payment methods, and blanks in which the user name, address, credit card number, etc., of the user are to be input. The customer inputs the user name, address, credit card number, etc., at step A4. The user terminal 10 sends the user name, address, credit card number, etc., together with the user ID, password, and player terminal ID to the server 30 as the digital contents rack creation request.

The server 30 registers the user name, address, credit card number, etc., together with the user ID, password, and player terminal ID with the contract information area in the user information area for the digital contents rack. The server 30 sets a contracted basic charge (for example, per month) in a use charge area in the contract information area. Further, the server 30 adds the use charge for contents information in the use charge area in the contract information area every time it registers contents information.

For example, at the end of every month, the server 30 reads the name, use charge, and credit card number from the contract information area in the user information area for the digital contents rack and charges a credit card company (not shown) over the network 100.

In the foregoing description, the use charge for contents are added in each registration of the contents. However, the use charge may be set to a flat charge at the time of contract or may be set in accordance with the number of registered player terminal IDs.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed:

1. A server computer system for selling digital contents, wherein the server computer system is connected via a network to user terminals, player terminals for replaying digital contents, and a sales center server storing the digital contents therein, and
the server computer system comprises:
creating means for creating a rack in a database as a depository for digital contents for each customer in response to a creation request from the user terminal;
storing means for storing digital contents received from the sales center server in the rack;
list sending means for receiving a request for a list of the digital contents from the player terminal via the network and creating the list from the customer's rack to send it to the player terminal; and
contents sending means for sending digital contents selected via the network by the customer using the player terminal to the player terminal in response to a download request for the selected digital contents.

2. The server computer system for selling digital contents according to claim 1, wherein, when the creating means receives via the network the rack creation request with customer information constituted by a user ID, a password, and one or more player terminal IDs that have been input by the user terminal, the creating means creates a rack for the user ID in the database and registers the customer information with the rack as user information on the rack, and when the creating means accepts via the network a request for change of the player terminal IDs registered with the rack, the creating means changes the player terminal IDs.

3. The server computer system for selling digital contents according to claim 2, wherein the sales center server causes the user terminal to input information including a delivery destination of the digital contents purchased by the customer and the user ID and password registered with the rack, then adds the input information to the purchased digital contents and delivers them to the server computer system via the network.

4. The server computer system for selling digital contents according to claim 2, wherein the server computer system comprises link information storing means for storing, in the rack of the customer who purchased the digital contents, link information including a contents ID identifying the digital contents when the digital contents received from the sales center server are identical with digital contents already stored in the rack.

5. The server computer system for selling digital contents according to claim 4, wherein, when the list sending means receives the request for a list with the user ID and one of the player terminal Ids from the player terminal, the list sending means creates the contents list for the user ID and the player terminal ID and sends it to the player terminal, and when the contents sending means receives the download request for digital contents with information including the user ID and the player terminal ID from the player terminal via the network, the contents sending means downloads contents information including the digital contents, the expiration date, and the maximum number of replays for the user ID and the player terminal ID to the player terminal from the rack.

6. A player terminal for replaying digital contents using a network, wherein the player terminal is connected via the network to user terminals, a server computer, and a sales center server storing the digital contents therein, and
the player terminal comprises:
displaying means for displaying a list of the digital contents stored in the server computer on a screen;
means for requesting download of digital contents selected by a customer from the list displayed by the displaying means; and
storing and replaying means for storing contents information including the downloaded digital contents and replaying the digital contents.

7. The player terminal according to claim 6, wherein the contents information includes the digital contents and information on the expiration date and the maximum number of replays for the player, and the player terminal comprises erasing means for erasing the digital contents stored by the storing and replaying means when the expiration date indicated by the information on the expiration date has been passed or when the digital contents has been replayed maximum times indicated by the information on the maximum number of replays.

8. A system for selling digital contents using a network, wherein user terminals, player terminals for replaying digital contents, a sales center server storing the digital contents therein, and a server computer system are interconnected via the network, and
the system for selling digital contents are constituted by: the server computer system comprising creating means for creating a rack in a database as a depository for digital contents for each customer in response to a creation request from the user terminal, storing means for storing digital contents received from the sales center server in the rack, list sending means for receiving a request for a list of the digital contents from the player terminal via the network and creating the list from the customer's rack to send it to the player terminal, and contents sending means for sending digital contents selected via the network by the customer using the player terminal to the player terminal in response to a download request for the selected digital contents;
the player terminal comprising displaying means for displaying a list of digital contents stored in the server computer on a screen, means for requesting download of the digital contents selected by a customer from the list displayed by the displaying means, and storing and replaying means for storing contents information including the downloaded digital contents and replaying the digital contents;
the sales center server comprising delivering means for accepting the customer's purchase request from the user terminal and delivering the digital contents purchased by the customer to the server computer via the network; and
the user terminal comprising requesting means for requesting, via the network, creation of the rack for each customer from the server.

9. The system for selling digital contents using a network according to claim 8, wherein the server computer system comprises:
the creating means for creating a rack for a user ID in the database and registers customer information with the rack as user information on the rack when the creating means receives via the network the rack creation request including the customer information constituted by the user ID, a password, and one or more player terminal IDs that have been input by the user terminal, and for changing the player terminal IDs when the creating means accepts via the network a request for change of the player terminal IDs registered with the rack;
link information storing means for storing, in the rack of the customer who purchased the digital contents, link information including a contents ID identifying the digital contents when the digital contents received from the sales center server are identical with digital contents already stored in the rack;
the list sending means for creating the contents list for the user ID and one of the player terminal IDs and sending it to the player terminal when the list sending means receives the request for a list with the user ID and the player terminal ID from the player terminal; and
the contents sending means for downloading contents information including the digital contents, the expiration date, and the maximum number of replays for the user ID and the player terminal ID to the player terminal from the rack when the contents sending means receives the download request for digital contents with information including the user ID and the player terminal ID from the player terminal via the network, and wherein
the sales center server causes the user terminal to input information including a delivery destination of the digital contents purchased by the customer and the user ID and password registered with the rack, then adds the input information to the purchased digital contents and delivers them to the server computer system via the network, and wherein
the player terminal comprises erasing means for erasing the digital contents stored by the storing and replaying means when the expiration date indicated by the information on the expiration date has been passed or when the digital contents have been replayed maximum times indicated by the information on the maximum number of replays.

10. The system for selling digital contents according to claim 9, wherein the network is the Internet.

11. A method for selling digital contents using a network, wherein a server computer system for selling digital contents, a sales center server storing digital contents therein, user terminals for purchasing digital contents from the sales center server, and player terminals for replaying the digital contents are connected to the network, via which the digital contents are sold, and the method comprises the steps of:
connecting the server computer system and the player terminal to the network;
presenting, on the network, a service by which the server computer system provides a digital contents rack for each customer;
storing, in the digital contents rack in the server computer system, digital contents purchased by a customer from the sales center server via the network with the user terminal; and
downloading the digital contents to the player terminal from the rack in response to a download request from the player terminal.

12. The method for selling digital contents according to claim 11, wherein the method further includes the step of collecting a use charge for the digital contents rack by the server computer system from each customer.

13. A machine-readable storage medium having recorded thereon a digital contents sales program for selling digital contents via a network by connecting, to the network, a server computer system for selling digital contents, a sales center server storing digital contents therein, user terminals for purchasing digital contents from the sales center server, and player terminals for replaying the digital contents, wherein the machine-readable storage medium comprises the processes of:
connecting the server computer system and the player terminal to the network;
presenting, on the network, a service by which the server computer system provides a digital contents rack for each customer;
storing, in the digital contents rack in the server computer system, digital contents purchased by a customer from the sales center server via the network with the user terminal; and
downloading the digital contents to the player terminal in response to a download request from the player terminal.

14. The machine-readable storage medium according to claim 13, wherein the machine-readable storage medium further includes the process of collecting a use charge for the digital contents rack by the server from each customer.
